(19) United States
(12) Patent Application Publication
(10) Pub. No.: US 2002/0133703 A1
(43) Pub. Date: Sep. 19, 2002

(54) On-line certificate of authenticity for collectibles cross-reference to related applications

(76) Inventor: Dan C. Morgan, San Jose, CA (US)

Correspondence Address: MOLLY D MCKAY, PC, 3207 E 22ND STREET, TULSA, OK, 74114-1823, US

(21) Appl. No.: 09/804,953

(22) Filed: Mar. 13, 2001

(51) Int. Cl. H04L 9/00

(52) U.S. Cl. 713/170

(57) ABSTRACT

An on-line method for issuing a certificate of authenticity for a collectible to a collector where the collector has personally witnessed the collectible being signed. The collector provides information on the collectible via the Internet to a central computer which stores the information for future reference by potential purchasers of the collectible and issues to the collector a certificate of authentication bearing a serialized hologram with bar code and an identical serialized hologram with bar code for attachment to the collectible. The collector must sign a statement on the certificate of authenticity that declares, under penalty of perjury, the information that the collector provided regarding the collectible is correct. Subsequent purchasers can access the central computer via the Internet to record their purchase of the collectible or to obtain historical information on the collectible.

### CROSS-REFERENCE TO RELATED APPLICATIONS

This invention is related to the invention taught in U.S. patent application Ser. No. 09/733,794 filed on Dec. 7, 2000 for the invention entitled “On Line Signature Verification of Collectibles”.

### BACKGROUND OF THE INVENTION

1. Field of the Invention

The present invention relates to a method employing an on-line computer system for issuing certificates of authenticity for a collectible object where the collector personally witnessed a celebrity, artist, or athlete signing the collectible.

2. Description of the Related Art

One of the problems faced by purchasers of collectibles that are inscribed with a signature of a celebrity, artist, or athlete is the lack of availability of standardized, legal certificates of authenticity for the collector who personally witnessed the signature. Until now there has not been a convenient way for the collector who personally witnessed a signature to generate a certificate of authenticity that complies with the legal requirements of every state. Although the law requires a certificate of authenticity be provided at the time of sale of a signed collectible, most collectors do not know that the law exists and do not have access to the necessary certificate of authenticity document. As a result, the collectors are unable to generate legally valid certificates of authenticity. In addition, there has never been an attempt to standardize the certificate of authenticity document, creating much confusion among collectors.

Many signed collectible items that are personally witnessed by the collector are sold without legally valid certificates of authenticity, and in most cases with no certificate at all. This leaves the purchaser with little, if any, guarantee that signature is authentic. The lack of legally valid certificates of authenticity for signed collectibles where a collector personally witnessed the signature is further complicated by the number of times the collectible item is resold. Authenticity of a signed collectible can not be proven and the chain of ownership can not be traced without a certificate of authenticity.

Although most dealers of signed collectibles provide certificates of authenticity upon sale, dealers are unwilling to provide access to certificates of authenticity to collectors due to risks associated with liability of the dealer. Because the current practice of collectors selling signed collectibles where the collector personally witnessed the signature is accomplished without valid legal certificates of authenticity, it is impossible for a purchaser to determine if the signature is authentic or forged. The current practice provides no distinction to the public between the collector who personally witnessed the signature on a collectible they are trying to sell and a person who is attempting to sell a forgery. This practice has created a wary market for signed collectibles. If the signature is a forgery, the purchaser is left with a worthless item, resulting in legal battles and disappointment. If the signature is authentic, the collector who personally witnessed the signature has no written proof or guarantee to back up their claim of authenticity. Collectors who personally witnessed the signature on a collectible item want to provide proof their item is real, but currently have no way to do this. Once the personally witnessed collectible item is properly certified, the value of the item will increase because it will be recognized as authentic.

The present invention addresses this problem by providing convenient access to legally valid certificates of authenticity via the Internet to collectors who personally witness a signature on a collectible item. The present invention provides the collector with a certificate of authenticity containing a guarantee in writing by the collector, and a signature of the collector stating under penalty of perjury that the signature was personally witnessed by the collector and is therefore authentic. A person who is attempting to sell a forgery will not utilize the online system of the present invention due to the extreme penalty associated with the admission that they are committing a crime by signing the certificate of authenticity.

On the other hand, a person selling a collectible with an authentic, personally witnessed signature will now be able to obtain a legal certificate of authenticity that is valid across the entire United States. This certificate of authenticity will prove to prospective purchasers that the signature on the collectible item is real. Identical serialized holograms with bar codes on the certificate of authenticity and on a label that is to be affixed to the collectible item will ensure the collectible is traceable. Both the label and a high quality certificate of authenticity that is suitable for framing will be delivered to the collector. All civil codes that govern certificates of authenticity across all 50 states will be adhered to, creating an industry wide, standardized certificate of authenticity document. In addition, every time a personally witnessed signed collectible item is sold, the new owner will have the opportunity to re-register the item over the internet and receive a valid certificate of ownership showing the history of the item and its chain of ownership.

### SUMMARY OF THE INVENTION

The present invention is a method for providing on-line certificates of authenticity for collectibles to collectors who have personally witnessed a celebrity autographing the collectible. The collector uses his personal computer to access a website for the invention that is run on a central computer. The collector provides information on himself and the collectible to obtain a customer identification number for the collector and a serial number for the collectible.

The information is stored in the central computer. A certificate of authenticity bearing a serialized hologram with bar code that is unique for the collectible and a second identical serialized hologram with bar code for permanently attaching to the collectible are printed and delivered to the collector.

The collector must sign a statement on the certificate of authenticity that declares, under penalty of perjury, that the information he provided regarding the collectible is correct. The collector will then secure the duplicate serialized hologram with bar code to the collectible.

A subsequent user that may be the original collector, a prospective purchaser of the collectible, or a new owner of the collectible can access this information in the central computer by using his personal computer. The subsequent user can access the historical information regarding the collectible. For a user who is the new owner of the collectible, the user may re-register the collectible to reflect this change in ownership. This new information is added to the historical information previously stored on the central computer in association with the serial number for the collectible and is available for future access.

### BRIEF DESCRIPTION OF THE DRAWINGS

FIGS. 1A and 1B are a flow diagram of a method of providing on-line certificates of authenticity for collectibles according to a preferred embodiment of the present invention.

### DETAILED DESCRIPTION OF THE PREFERRED EMBODIMENT INVENTION

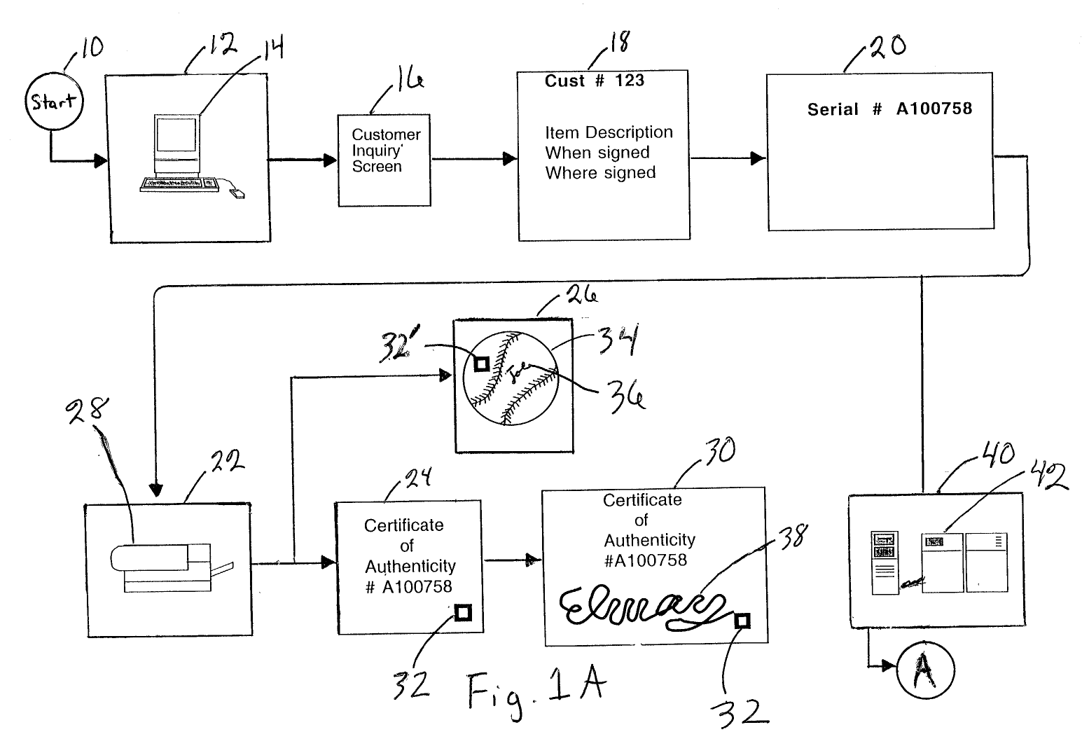

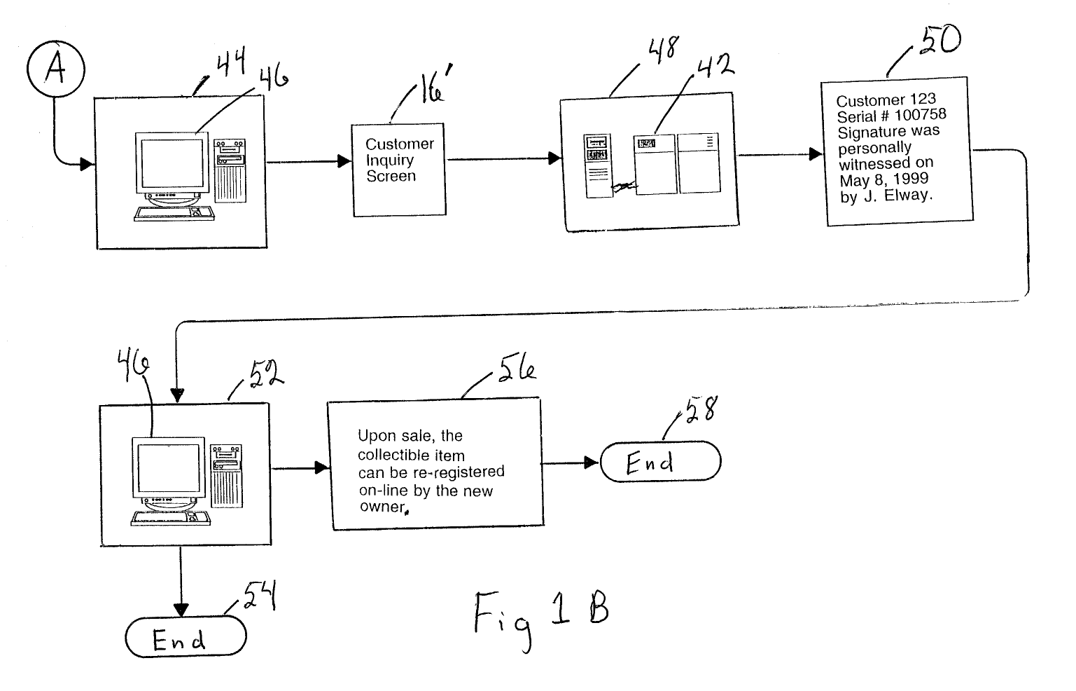

Referring now to the drawings there is illustrated a method for providing on-line certificates of authenticity for collectibles according to a preferred embodiment of the present invention. Beginning with a FIG. 1A, the process will be described. The process begins at a start box, indicated in numeral 10 in FIG. 1A. The first thing that happens, as indicated in box 12, is the collector uses his personal computer 14 to access a website for the invention that is run on a central computer. As illustrated in box 16, when the collector connects to website, the collector must first complete a customer inquiry screen with customer information for the collector. As shown in box 18, once the customer information is provided, a customer identification number is assigned to the collector, and the collector then answers a series of questions related to the collectible item being certified.

The information being requested in box 18 will satisfy current federal legal requirements and will include, but not be limited to, the following items of information:

1) description of the collectible item,

2) the name of the celebrity who autographed it,

3) the date and place the signature was autographed in the presence of the collector,

4) limited edition information such as the sequence number of the collectible and the total number in the limited edition,

5) the name of a witness to the autograph signing (if applicable),

6) an express warranty or guarantee the signature was personally witnessed,

7) the collector's true legal name and street address,

8) any identifying serial number on the collectible item, and

9) any additional information that may add to the legitimacy of the autograph such as the name of the trade show company that hired the celebrity, artist, or athlete.

Once the collector has provided the requested information, a serial number is assigned to the collectible, as indicated by box 20. As illustrated in boxes 22, 24 and 26, a printer 28 will next print two items: a certificate of authenticity 30 bearing a serialized hologram with bar code 32 that is unique for that collectible, and a second identical serialized hologram with bar code 32′ for permanently attaching to the collectible or object 34. Both of these two items 30 and 32′ will be provided to the collector via mail from the location of the printer 28.

Upon receiving these two items 30 and 32′, the collector must sign his name 38 on a statement contained on the certificate of authenticity 30 that declares, under penalty of perjury, that the information he provided regarding the collectible 34 is correct. The collector will then secure the duplicate serialized hologram with bar code 32′ to the collectible 34.

As shown in box 40, all of the information relating to the collector, the collectible 34, and the certificate of authenticity 30 will be stored in a central computer 42 for retrieval at a future time.

Referring now to FIG. 1B, as illustrated in box 44, a new user can access this information by using his personal computer 46 to connect to the same website on which the original collector registered the collectible. This new user may be the original collector, a prospective purchaser of the collectible 34, or a new owner of the collectible 34. The user then provides the information requested on the customer inquiry screen 16′. The information that was previously stored on the central computer 42 relating to the collectible 34 is then retrieved and displayed, as shown by boxes 48 and 50, respectively.

As illustrated in box 52, this information is displayed on the screen of the user's computer 46 and can be printed by the user. If the user is just seeking information on the collectible 34, then the process ends, as shown in box 54. As illustrated in box 56, if the user has purchased the collectible 34, the user may reregister the collectible 34 on-line by providing information on the new owner and their purchase of the collectible 34 similar to the way that the original collector registered the collectible 34. All of this new information is added to the historical information previously stored on the central computer 42 in association with the serial number for the collectible 34. This ends the process, as indicated by box 58, until a new user again accesses the information via the website to check on the authenticity of the collectible 34, to check on the history of the collectible 34, or to re-register the collectible that they have purchased.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A method of providing on-line certificates of authenticity for collectibles where a collector has personally witnessed the collectible being signed comprising the following steps:
a. connecting an originating computer via an online communication system to a central computer,
b. providing information from the originating computer to the central computer about a collector and a collectible for which the collector seeks to obtain a certificate of authentication in order to obtain a user number for the collector and a serial number for the collectible from the central computer and storing the information about the collector and the collectible on the central computer,
c. printing and providing to the collector a certificate of authenticity bearing a serialized hologram with bar code and an identical serialized hologram with bar code for attachment to the collectible,
d. requiring the collector to sign a statement on the certificate of authenticity that declares, under penalty of perjury, the information that the collector provided regarding the collectible is correct.

2. A method of providing on-line certificates of authenticity for collectibles according to claim 1 further comprising the following step that occurs after step d:
e. allowing users to access information on a collectible that is stored on the central computer via an online communication system.

3. A method of providing on-line certificates of authenticity for collectibles according to claim 1 further comprising the following step that occurs after step d:
f. allowing a subsequent purchaser of the collectible to register their ownership of the collectible by connecting their computer via an online communication system to a central computer and providing information to the central computer about the subsequent purchaser.
